(19) United States
(12) Patent Application Publication
(10) Pub. No.: US 2017/0363475 A1
(43) Pub. Date: Dec. 21, 2017

(54) MULTI-SPECTRAL FLAME DETECTOR WITH RADIANT ENERGY ESTIMATION

(71) Applicant: General Monitors, Inc., Lake Forest, CA (US)

(72) Inventors: Shankar B. Baliga, Irvine, CA (US); Javid Huseynov, Elmsford, NY (US); John G. Romero, Rancho Santa Margarita, CA (US); Cristian Filimon, Orange, CA (US)

(21) Appl. No.: 15/693,233

(22) Filed: Aug. 31, 2017

Related U.S. Application Data
(62) Division of application No. 14/162,645, filed on Jan. 23, 2014.

(51) Int. Cl. G01J 5/00; G08B 17/12; G01J 5/02; G08B 31/00

(52) U.S. Cl. CPC G01J 5/0018; G08B 31/00; G08B 17/12; G01J 5/0014; G01J 5/025; G01J 5/026

(57) ABSTRACT

A flame detector configured for radiant energy monitoring, quantification, and information transmission. The system has at least one optical sensor channel, each including an optical sensor configured to receive optical energy from a surveilled scene within a field of view, the channel producing a signal providing a quantitative indication of the optical radiation energy received by the optical sensor within a sensor spectral bandwidth. A processor is responsive to the signal from the at least one optical sensor channel to provide a flame present indication of the presence of a flame, and a quantitative indication representing a magnitude of the optical radiation energy from the surveilled scene. An Artificial Neural Network may be used to provide an output corresponding to a flame condition.

### CROSS-REFERENCE TO RELATED APPLICATION

This application is a division of U.S. application Ser. No. 14/162,645 filed Jan. 23, 2014, the entire contents of which are hereby incorporated by reference.

### BACKGROUND

Flame detectors for industrial safety in hazardous locations have one or more optical sensors for detecting electromagnetic radiation, including visible, infrared or ultraviolet, which is indicative of the presence of a flame. A flame detector may detect and measure infrared (IR) radiation, for example at around 4.3 microns, a wavelength that is characteristic of the spectral emission peak of carbon dioxide produced by burning hydrocarbons. The optical sensors used in single through multi-sensor flame detectors continuously monitor the total radiation incident from all sources of radiation in the spectral range being sensed within their field of view. The sources of radiation include both flame sources that are to be detected, and non-flame nuisance sources such as sunlight, reflections, arc welding, heat generating equipment and structures that are typical of an industrial setting. Though such radiometric information may be continuously monitored by the optical sensors, industrial flame detectors for safety applications are “go no-go” devices with a normal quiescent state followed by warning and alarm states when a fire is detected.

Flame detectors may produce false alarms caused by the instrument's inability to distinguish between radiation emitted by flames and that emitted by other nuisance sources such as those listed above.

### BRIEF DESCRIPTION OF THE DRAWINGS

Features and advantages of the disclosure will readily be appreciated by persons skilled in the art from the following detailed description of exemplary embodiments thereof, as illustrated in the accompanying drawings, in which:

FIG. 1 is a schematic block diagram of an exemplary embodiment of a flame detection system utilizing multiple optical sensors.

FIG. 1A illustrates an exemplary sensor housing structure suitable for the optical sensors of a multi-spectral flame detection system.

FIG. 2 is an electronic block diagram of an exemplary embodiment of the analog front end of the multi-spectral flame detection system of FIG. 1.

FIG. 3 is a functional flow diagram of an exemplary embodiment of signal processing functions of the flame detection system of FIG. 1.

FIG. 4A is an exemplary flow diagram of an exemplary embodiment of pre-processing functions utilized in the multi-spectral flame detection system illustrated in FIG. 3.

FIG. 4B is a flow diagram of an exemplary embodiment of radiant energy computation utilized in the multi-spectral flame detection system illustrated in FIGS. 1-4A.

FIG. 5 illustrates an exemplary embodiment of the ANN processing utilized in the multi-spectral flame detection system illustrated in FIGS. 1-4.

FIG. 6 is a functional block diagram of another exemplary embodiment of signal processing functions of a flame detection system as in FIG. 1.

FIG. 7 is an illustration of exemplary 0-20 mA analog current interfaces for evaluating detected conditions, both quantitatively and qualitatively.

FIG. 8 is a functional block diagram of another exemplary embodiment of signal processing functions of a flame detection system as in FIG. 1.

FIG. 9 is a functional block diagram of another exemplary embodiment of signal processing functions of a flame detection system as in FIG. 1.

### DETAILED DESCRIPTION

In the following detailed description and in the several figures of the drawing, like elements are identified with like reference numerals. The figures are not to scale, and relative feature sizes may be exaggerated for illustrative purposes.

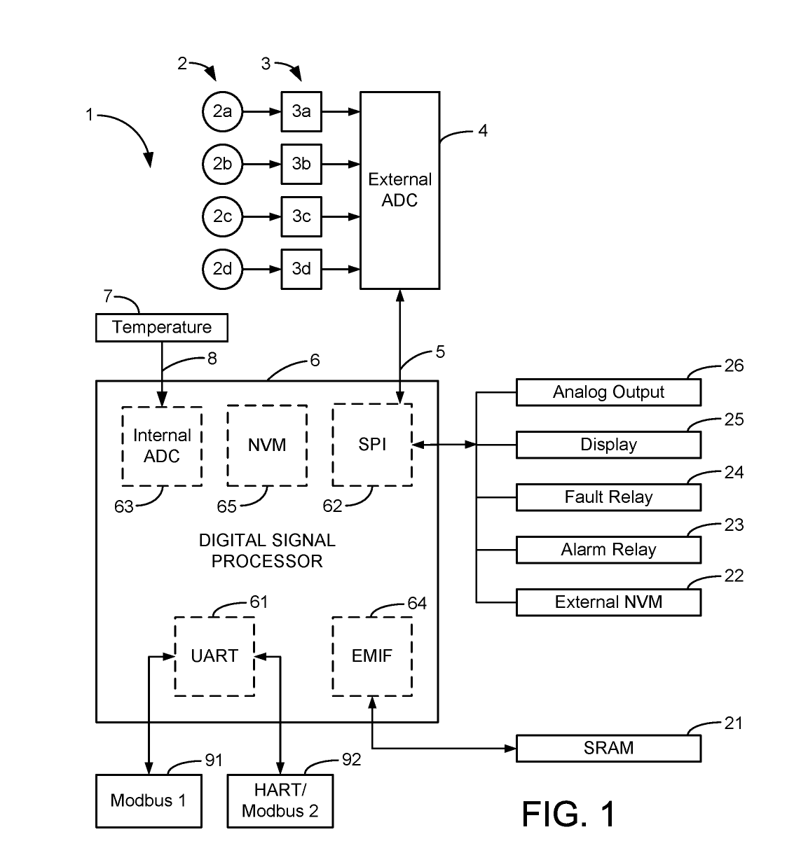

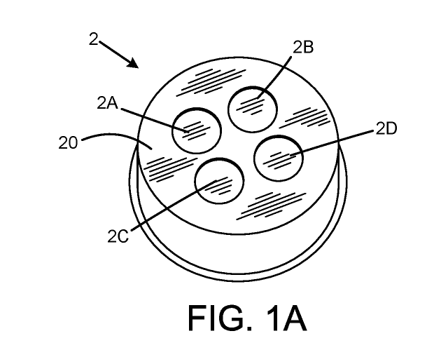

FIG. 1 illustrates a schematic block diagram of an exemplary embodiment of a multiple sensor flame detection system 1 comprising four optical sensors or sensing elements 2a, 2b, 2c, 2d. In this exemplary embodiment, the optical sensors are for sensing energy in the infrared spectrum. In an exemplary embodiment, the analog signals generated by the sensors are conditioned by electronics 3a, 3b, 3c, 3d and then converted into digital signals by the analog to digital converter (ADC) 4.

In the exemplary embodiment of FIG. 1, the multi-spectral flame detection system 1 includes an electronic controller or signal processor 6, e.g., a digital signal processor (DSP), an ASIC or a microcomputer or microprocessor based system. In an exemplary embodiment, the controller 6 may comprise a DSP, although other devices or logic circuits may alternatively be deployed for other applications and embodiments. In an exemplary embodiment, the signal processor 6 also includes a dual universal asynchronous receiver transmitter (UART) 61 as a serial communication interface (SCI), a serial peripheral interface (SPI) 62, an internal ADC 63 that may be used to monitor a temperature sensor 7, an external memory interface (EMIF) 64 for an external memory (SRAM) 21, and a non-volatile memory (NVM) 65 for on-chip data storage. Modbus 91 or HART 92 protocols may serve as interfaces for serial communication over UART 61. Both protocols are well-known in process industries, along with others such as PROFIbus, Fieldbus and CANbus, for interfacing field instrumentation to a computer or a programmable logic controller (PLC).

In an exemplary embodiment, signal processor 6 receives the digital detector signals 5 from the ADC 4 through the SPI 62. In an exemplary embodiment, the signal processor 6 is connected to a plurality of other interfaces through the SPI 62. These interfaces may include an external NVM 22, an alarm relay 23, a fault relay 24, a display 25, and an analog output 26.

In an exemplary embodiment, the analog output 26 may be a 0-20 mA output. In an exemplary embodiment, a first current level at the analog output 26, for example 16 mA, may be indicative of a flame warning condition, a second current level at the analog output 26, for example 20 mA, may be indicative of a flame alarm condition, a third current level may be indicative of normal operation, e.g., when no flame is present, and a fourth current level at the analog output 26, for example 0 mA, may be indicative of a system fault, which could be caused by conditions such as electrical malfunction. In other embodiments, other current levels may be selected to represent various conditions. The analog output 26 can be used to trigger a fire suppression unit, in an exemplary embodiment.

In an exemplary embodiment, the signal processor 6 is programmed to perform pre-processing and ANN processing, as discussed more fully below.

In an exemplary embodiment, the plurality of detectors 2 comprises a plurality of spectral sensors, which may have different spectral ranges and which may be arranged in an array. In an exemplary embodiment, the plurality of detectors 2 comprises optical sensors sensitive to multiple wavelengths. At least one or more of detectors 2 may be capable of detecting optical radiation in spectral regions where flames emit strong optical radiation. For example, the sensors may detect radiation in the UV to IR spectral ranges. Exemplary sensors suitable for use in an exemplary flame detection system 1 include, by way of example only, silicon, silicon carbide, gallium phosphate, gallium nitride, and aluminum gallium nitride sensors, and photoelectric tube type sensors. Other exemplary sensors suitable for use in an exemplary flame detection system include IR sensors such as, for example, pyroelectric, lead sulfide (PbS), lead selenide (PbSe), and other quantum or thermal sensors. In an exemplary embodiment, a suitable UV sensor operates in the 200-260 nanometer region. In an exemplary embodiment, the photoelectric tube-type sensors and/or aluminum gallium nitride sensors each provide “solar blindness” or an immunity to sunlight. In an exemplary embodiment, a suitable IR sensor operates in the 4.3 micron region specific to hydrocarbon flames, and/or the 2.9 micron region specific to hydrogen flames.

In an exemplary embodiment, the plurality of sensors 2 comprise, in addition to sensors chosen for their sensitivity to flame emissions (e.g., UV, 2.9 micron and 4.3 micron), one or more sensors sensitive to different wavelengths to help identify and distinguish flame radiation from non-flame radiation. These sensors, known as immunity sensors, are less sensitive to flame emissions, however, provide additional information on infrared background radiation. The immunity sensor or sensors detect wavelengths not associated with flames, and may be used to aid in discriminating between radiation from flames and non-flame sources. In an exemplary embodiment, an immunity sensor comprises, for example, a 2.2 micron wavelength detector. A sensor suitable for the purpose is described in U.S. Pat. No. 6,150,659.

In the exemplary embodiment of FIG. 1, the flame detection system 1 comprises an array of four sensors 2a-2d, which incorporates spectral filters respectively sensitive to radiation at 4.9 micron (2a), 2.2 micron (2b), 4.3 micron (2c) and 4.45 micron (2d). In an exemplary embodiment, the filters were selected to have narrow operating bandwidths, e.g. on the order of 100 nanometers, so that the sensors are only responsive to radiation in the respective operating bandwidths, and block radiation outside of the operating bands. In an exemplary embodiment, the optical sensors 2 are packaged closely together as a cluster or combined within a single detector package. This configuration leads to a smaller, less expensive sensor housing structure, and also provides for a more unified optical field of view of the instrument. An exemplary detector housing structure suitable for the purpose is the housing for the detector LIM314, InfraTec GmbH, Dresden, Germany. FIG. 1A illustrates an exemplary sensor housing structure 20 suitable for use in housing the sensors 2a-2d in an integrated unit.

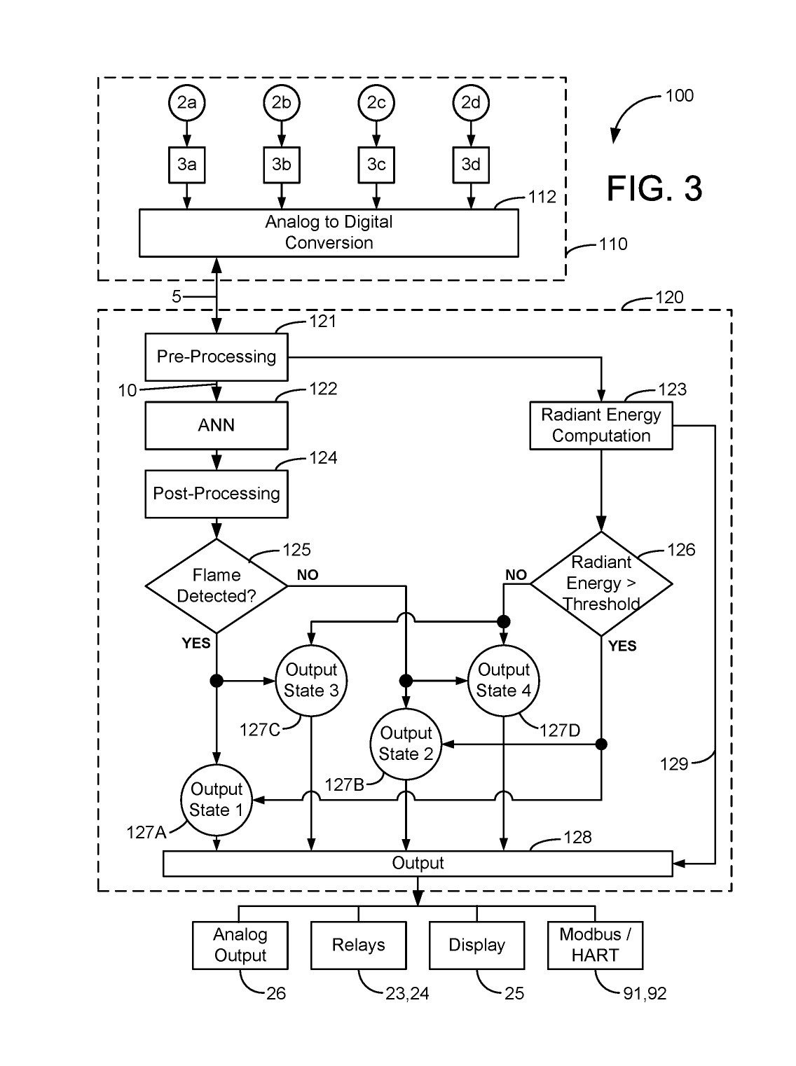

Referring now to the four optical sensors 2a, 2b, 2c, 2d, in an exemplary embodiment the four sensors continuously monitor the total radiation incident from all sources of radiation in the spectral range being sensed within their field of view. The instrument may be configured to provide the radiometric information computed by a particular infrared channel of interest, for example, channel 2c at 4.3 um could be monitored as a guide to flame intensity. Likewise, flame channel sensor outputs 2c and 2d may be combined as a guide to flame intensity. A number of algebraic combinations are possible with four optical sensor outputs, such as, total, average, weighted average, or subtractions. Such computations could be performed onboard the instrument or remotely by the user on a control room computer using data sent continually, periodically, on request, or triggered by an event. The radiant energy computation could be used to set a flame detection threshold as described via FIG. 3. The radiant heat output (RHO) of fires generated by burning various fuels is of great interest as it is a measure of the fire's destructive potential. The radiant energy monitored by the optical sensors is in proportion to the radiant energy (joules) or heat generated at the sensor specific wavelengths. The Health and Safety Executive (HSE), U.K., has established guidelines on the effects of fire radiation exposure to humans. To quote, “Escape is assumed at 5 kWm-2, but fatalities within minutes assumed at 12.5 kWm-2 and instantaneous death at 37.5 kWm-2.” Radiant heat output monitoring is thus important from the aspect of its severity and effects on personnel and equipment involved in an unfortunate incident.

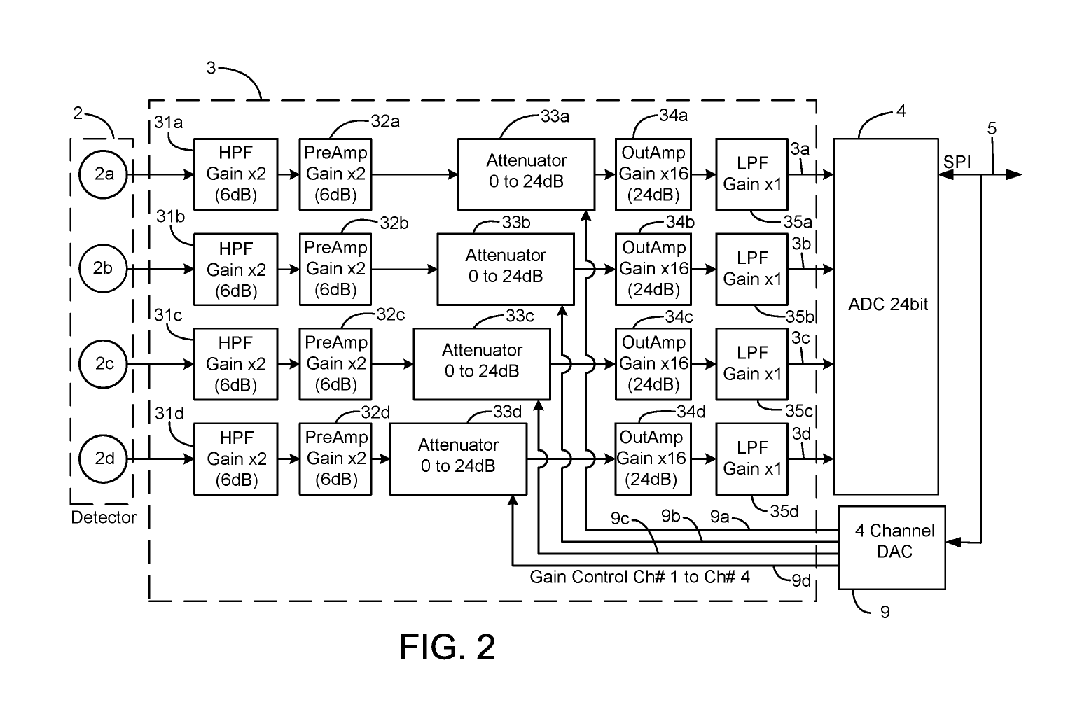

FIG. 2 is an exemplary electronic block diagram of the analog front end of the multi-spectral flame detection system. Each infrared (IR) sensor is provided with an independent, automatic gain control (AGC) in the electronic front end 3. In an exemplary embodiment, the variable gain control is provided under processor control by attenuating the electronic signal in the blocks marked 33a, 33b, 33c, 33d for each optical sensor 2a, 2b, 2c, 2d. A four channel digital to analog converter (DAC) 9 sends commands 9a, 9b, 9c, 9d to the individual attenuators 33a, 33b, 33c, 33d. In an exemplary embodiment, a 0 to 24 dB attenuation range is possible, leading to a gain control from 30 down to 1 in a continuous manner. The highest gain of 30, corresponding to 0 dB attenuation, is the electronic gain in the absence of IR, with lower gains (higher attenuation) kicking in as the IR intensity is increased. For very intense IR radiation, as produced by a large fire or a close up and intense modulated heat source, the AGC operates with minimum gain. In this manner, the AGC scheme provides for optimal performance in the detection of small, distant fires (gain=30) as well for the detection of large or close up fires (gain=1), with independent gain control for each IR sensor channel. The scheme of FIG. 2 thus eliminates, except perhaps for the most severe cases, the saturation effects that can impact the performance of optical flame detectors. Input signal conditioning before the attenuator block is provided to each sensor channel by high pass filters 31a, 31b, 31c, 31d and preamplifiers 32a, 32b, 32c, 32d, while further signal conditioning is provided by output amplifiers 34a, 34b, 34c, 34d and low pass filters 35a, 35b, 35c, 35d. In the exemplary embodiment illustrated in FIGS. 1 and 2, the processing in the electronic front end 3 shown in FIG. 2, including the AGC, is performed externally to the DSP 6. The output 5 from the ADC 4 is sequential data corresponding to the respective four sensors, i.e. in a time-multiplexed manner.

The value of the total electronic gain provided by fixed gain 31, 32, 34, 35 and AGC gain 33 that is variable, in the electronic front end 3, for each of the four IR sensor channels (a, b, c, d) is a continuous indication in inverse proportion to the IR radiation received by the IR sensors within their spectral and temporal bandwidth.

The radiant energy received by each IR sensor may be calculated by the DSP 6 as follows

Enᵢ=Kn*Enₒ/(Fixed Gain*Variable Gain)

where Enₒ is the value sent to the ADC 4 from the electronic front end 3 as signals 3a, 3b, 3c and 3d respectively, and Enᵢ is a measure of the radiant energy received by the IR sensors within their spectral and temporal bandwidth. In the above computation, the gain values are numerical and not decibel, and n represents the IR sensors 1 through 4 (or n in general). Kn is a calibration constant that relates the IR sensor signals to known radiometric sources such as a blackbody and aids in converting the measurement into radiometric units of measurement such as milliWatts. The computation of the measure of radiant energy Enᵢ is performed continuously by DSP 6 and available for further computational analysis and processing as described below.

The radiant energy measure Enᵢ may be put to use, e.g., in an exemplary embodiment the values of the AGC plus the fixed gain of the two flame sensing channels (4.3 um and 4.45 um) could be used to combine and average Ecᵢ and Edᵢ to output an estimation of the radiant heat generated by the fire that caused a flame detection event. Such information may be very useful as a record of the radiated intensity of the fire that caused the alarm, including “trending” information on RHO that captures the evolution of the fire from before alarms were triggered till such time as the fires were finally extinguished. It is also well known to those skilled at studying fires and flame radiation that no two fire events are identical: even when a standard pan fire is lit the RHO varies as the fire grows and decays, along with effects caused by wind, and fuel contaminants such as water. The need, therefore, is well established to link the detection of a flame with the growth through decay of the fire along with environmental factors; radiant energy measurements by the flame optical sensors themselves provide the relevant information at no additional cost.

FIG. 3 is a simplified functional block diagram of an exemplary flame detection system 100. The system includes a sensor data collection function 110, which collects the analog conditioned sensor signals 3a, 3b, 3c, and 3d from the multiple optical sensors 2a, 2b, 2c, and 2d respectively, and converts the sensor signals into digital form 112 for processing by the digital signal processor. Processing algorithms 120 are then applied to the sensor data, including signal pre-processing 121, ANN validation function 122, radiant energy computation 123, and post-processing 124, leading to decision block 125. In an exemplary embodiment, the radiant energy computation 123 from sensors 2a, 2b, 2c, 2d is compared against a preset threshold 126, while the post processed ANN provides a determination as to whether the optical signals are generated by a real flame event 125. In an exemplary embodiment, the combination of the decision blocks 125 and 126 results in four combinations:
Output state 127A for combination (1) Yes to Flame Event & (2) Radiant Energy≧Threshold
Output state 1278 for combination (1) No to Flame Event & (2) Radiant Energy≧Threshold
Output state 127C for combination (1) Yes to Flame Event & (2) Radiant Energy<Threshold
Output state 127D for combination (1) No to Flame Event & (2) Radiant Energy<Threshold

Output state 127A corresponds to the case of flames being detected and one that exceeds the radiant energy threshold (126). The threshold value (126) may be considered a flame detection threshold; the user may choose to set a higher alarm threshold for alarm relay 23 in the output block 128. Output state 127A also includes the more general case of real flames detected in the presence of a false alarm (background noise), as the ANN is trained to classify such a situation as a real flame event. Output state 127B corresponds to the situation where the large measured radiant energy has been diagnosed as not being emitted by a fire, but rather from a false alarm source. Output state 127C corresponds to the detection of a real fire, but small enough in magnitude to produce radiant energy less than the threshold (126). Output state 127C may be considered to represent a minor fire and to provide the user with a warning of an imminent larger fire. The user would typically not take corrective action, and would be advised to monitor the facility more closely. Output state 127D corresponds to the situation where nothing much is happening; there is no evidence of a fire and the background radiant energy is at a value considered insignificant.

The information from output states 127A, 1278, 127C, and 127D is continuously transmitted via output block 128 to the relays 23 and 24, display 25, analog output 26, and one or more external communication interfaces such as Modbus 91 and HART 92. Output block 128 may generate signals derived from or representing the processing algorithm outputs 127A-127D and 129, and may be programmed by the user to define what is sent to the various user interfaces, e.g., the display may indicate the radiant energy regardless of it being caused by a fire or a false alarm, or the display may indicate the radiant energy only when it is determined to be caused by a real fire. It is also possible for the user to configure output block 128 to directly show just the radiant energy measured and transmitted via 129 regardless of the status of the output states 127A, 1278, 127C, and 127D; in this manner, the effect of ANN processing and decision making can be bypassed temporarily or permanently, as required. The user may also set an alarm radiant energy threshold via output block 128 to activate alarm relay 23 that is higher than the minimum flame detection threshold used in decision block 126. The user may also program the output block 128 with a user settable time delay to ensure that an ANN determined flame event lasts for certain duration before taking corrective action, via, for example, alarm relay 23.

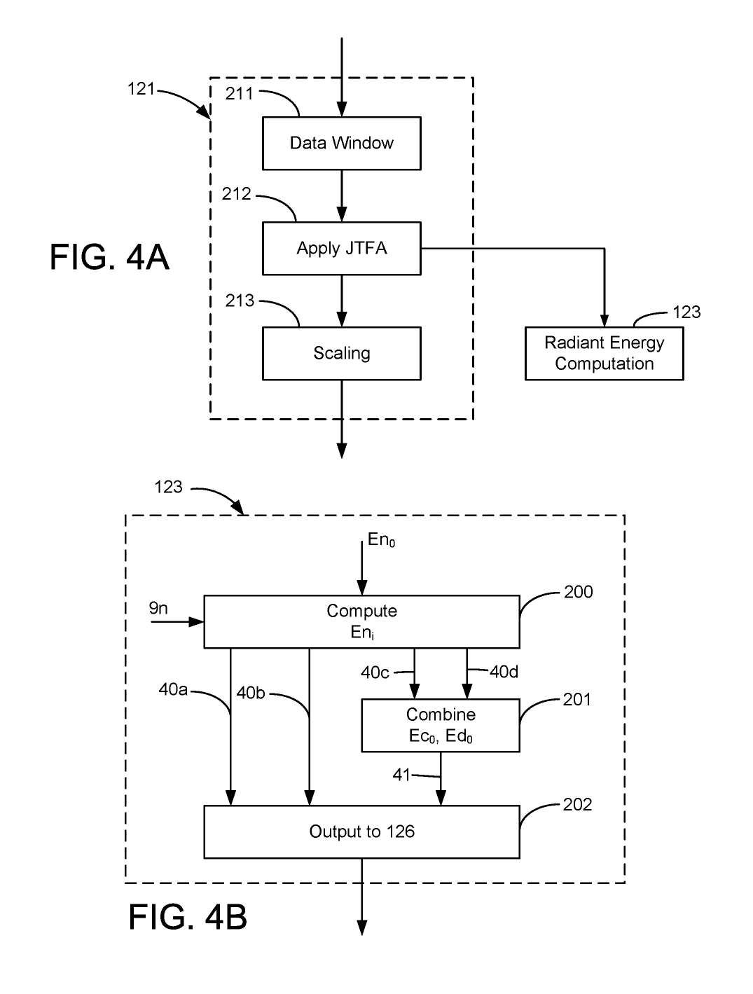

In an exemplary embodiment, an objective of the pre-processing function 121 is to establish a correlation between the frequency and time domain of the optical signals. In an exemplary embodiment shown in FIG. 4A, the pre-processing function 121 includes applying 211 a data windowing function and a Joint Time-Frequency Analysis (JTFA) function 212 independently to each digitized optical sensor signal. In an exemplary embodiment, data windowing function 211 involves applying one of a Hanning, Hamming, Parzen, rectangular, Gauss, exponential or other appropriate data windowing function. In an exemplary embodiment, the data window function 211 comprises a Hamming window function which is described by a cosine type function:

$${W}^{Hm} = \frac{1}{2} \{ 1.08 - 0.92 cos ( \frac{2 π n}{N - 1} ) \}$$

where N is number of sample points (e.g. 512) and n is between 1 and N.

In an exemplary embodiment of the data preprocessing 121, the Hamming window function 211 is applied to a raw input signal before applying a JTFA function 212. This data windowing function alleviates spectral “leakage” of the signal and, thus, improves the accuracy of ANN classification.

Referring again to FIG. 4A, in an exemplary embodiment, JTFA 212 encompasses a Discrete Fourier Transform. The JTFA may also encompass a Short-Time Fourier Transform (STFT) with a shifting time window (also known as Gabor transform), or a Discrete Wavelet Transform (DWT). The output of the Fourier transform may be filtered to remove frequencies outside a frequency band of interest to IR flame detection, for example, frequencies greater than 20 Hz. The JTFA application is followed by a scaling operation 213; this normalizes the data by subtracting the mean and dividing by the standard deviation to effectively scale the inputs to the ANN 122 (FIG. 3). In an exemplary embodiment, coefficients and algorithms used for the windowing function 211, JTFA 212, and the scaling function 213 are stored in non-volatile memory. In an exemplary embodiment, the coefficients may be stored in NVM 65 (FIG. 1).

Referring again to FIG. 3 and FIG. 4A, the data pre-processed by the windowing function and the JTFA operation is also fed into the block 123 for radiant energy computation. In an exemplary embodiment, the radiant energy is computed by summing over various frequency magnitudes computed by the Fourier Transform and normalized by a calibration factor. In another exemplary embodiment, the radiant energy is derived directly from the time domain computed signals Enᵢ described earlier rather than summing frequency component magnitudes generated by the Fourier Transform described above. Each of Eaᵢ, Ebᵢ, Ecᵢ and Edᵢ may be outputted, averaged and/or combined. The computed radiant energy may be compared against a threshold value in decision block 126 (FIG. 3).

FIG. 4B illustrates the exemplary embodiment where, as described earlier, the values of the AGC plus the fixed gain of the two flame sensing channels (2c at 4.3 um and 2d at 4.45 um) may be used to compute, combine and average Ecᵢ and Edᵢ to output an estimate of the radiant heat generated by the fire that caused a flame detection event. The preprocessed time domain signals Enₒ are sent from block 121 to radiant energy computation block 123. Values of Enᵢ are calculated as described above using fixed and variable (AGC) gain values in the compute block 200. Values of Eaᵢ and Ebᵢ (representing radiant energy at the immunity sensor wavelengths of 4.9 um and 2.3 um) may be sent (40a, 40b) to output block 202 directly while Ecᵢ and Edᵢ representing radiant energy at the two flame sensing wavelengths (40c, 40d) could be combined in 201 by averaging the values and then transmitted 41 via output block 202 to the decision block 126 for comparison with a previously stored threshold value.

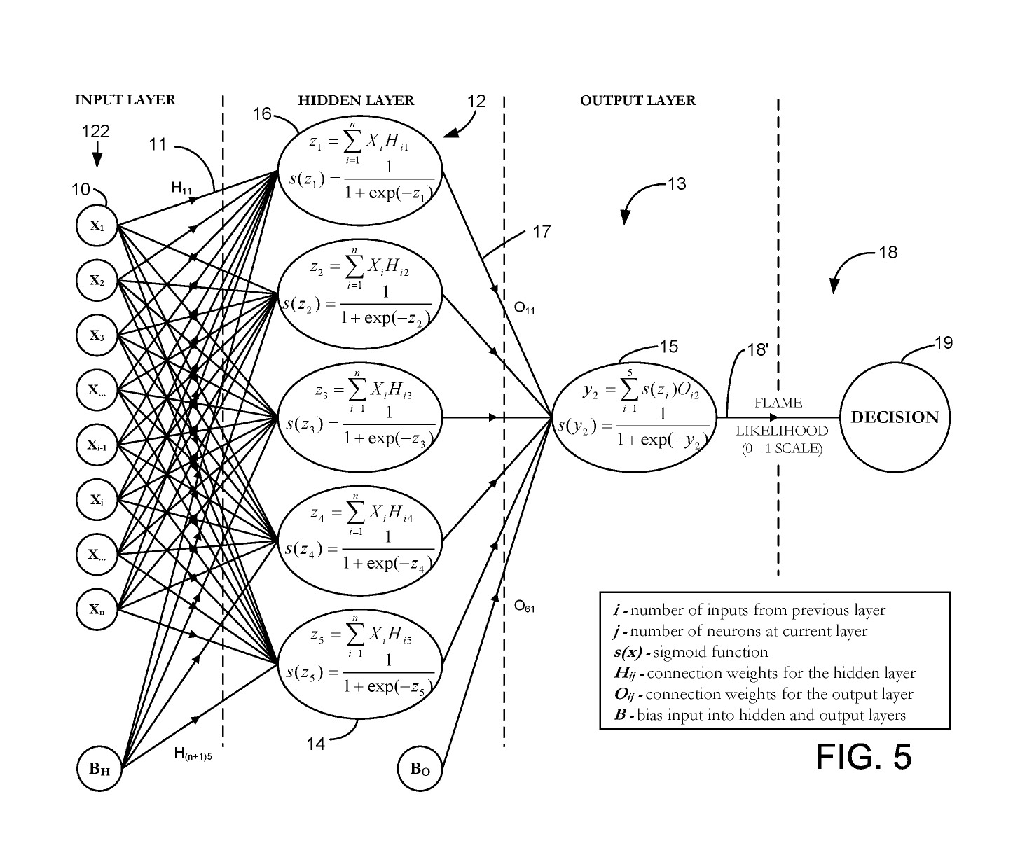

FIG. 5 illustrates a functional block diagram of an exemplary embodiment of ANN processing 122. ANN processing 122 may comprise two-layer ANN processing. In an exemplary embodiment, ANN processing 122 includes receiving a plurality of pre-processed signals 10 (x₁-xᵢ) generated by the optical sensors 2a, 2b, 2c, and 2d (corresponding to the data windowed 211, JTFA processed 212, and scaled 213 signals resulting from the pre-processing 121 shown in FIG. 4A), a hidden layer 12 and an output layer 13. In other exemplary embodiments, ANN processing 122 may comprise a plurality of hidden layers 12. The pre-processed signals 10 from 121 (x₁-xᵢ) include the respective pre-processed signals from optical sensors 2a, 2b, 2c, and 2d in a fixed, serial order in the input layer of ANN processing 122. The fixed order is the order generated by the ADC 4 (FIGS. 1 and 2) to stream data out to the DSP. The same order is maintained by 121 in FIG. 3.

In an exemplary embodiment, the hidden layer 12 includes a plurality of artificial neurons 14, for example five neurons as shown in FIG. 5. The number of neurons 14, known as hidden neurons, may depend on the non-linearity of classification achieved by the ANN processing 122 during the training. In an exemplary embodiment, the output layer 13 includes a plurality of targets 15 (or output neurons) corresponding to various conditions. The number of targets 15 may vary from one to multiple. The exemplary embodiment of FIG. 5 employs one target neuron 15, which outputs the event likelihood 18 to decision processing 19.

In an exemplary embodiment, the NVM 65 (FIG. 1) holds synaptic connection weights Hᵢⱼ 11 for the hidden layer 12 and synaptic connection weights Oⱼₖ 17 for the output layer 13. In an exemplary embodiment, the signal processor 6 sums the plurality of pre-processed signals 10 at neuron 14, each multiplied by the corresponding synaptic connection weight Hᵢⱼ 11. A non-linear activation (or squashing) function 16 is then applied to the resultant weighted sum zᵢ for each of the plurality of hidden neurons 14. In an exemplary embodiment, shown in FIG. 5, the activation function 16 is a unipolar sigmoid function (s(zᵢ)). In other embodiments, the activation function 16 can be a bipolar function or another appropriate activation function. In an exemplary embodiment, a bias B_{H} is also an input to the hidden layer 12. In an exemplary embodiment, the bias B_{H} has the value of one. Referring again to FIG. 5, in an exemplary embodiment, the neuron outputs (s(zᵢ)) are input to the output layer 15; a bias B_{O} is also an input to the output layer 15. In an exemplary embodiment, the outputs (s(zᵢ)) are each multiplied by a corresponding synaptic connection weight Oⱼₖ 17 and the corresponding results are summed for output target 15 in the output layer 13, resulting in a corresponding sum yⱼ.

Thus, as depicted in FIG. 5, the signal-processed inputs Xᵢ 10 are connected to hidden neurons 14, and the connections between input and hidden layers are assigned weights Hᵢⱼ 11. At every hidden neuron, the multiplication, summation and sigmoid function are applied in the following order.

$${Z}_{j} = {\sum }_{i = 1}^{n} {X}_{i} {H}_{ij}$$

$$S ( {Z}_{j} ) = \frac{1}{1 + exp ( - {Z}_{j} )}$$

The outputs of sigmoid function S(Zⱼ) from the hidden layer 12 are introduced to the output layer 13. The connections between hidden and output layers are assigned weights Oⱼₖ 17. Now at every output neuron multiplication, in this exemplary embodiment, summation and sigmoid function are applied in the following order:

$${Y}_{k} = {\sum }_{i = 1}^{n} S ( {Z}_{j} ) {O}_{jk}$$

$$S ( {Y}_{k} ) = \frac{1}{1 + exp ( - {Y}_{k} )}$$

In an exemplary process of ANN training, the connection weights Hᵢⱼ and Oⱼₖ are constantly optimized by the Back Propagation (BP) algorithm. In an exemplary embodiment, the BP algorithm is based on mean root-square error minimization using the conjugate-gradient (CG) descent method. The algorithm is applied using MATLAB, a tool for numerical computation and data analysis, to optimize the connection weights Hᵢⱼ and Oⱼₖ. These connection weights are then used in ANN validation, to compute the ANN outputs S(Yₖ), which are used for final decision making.

In an exemplary embodiment, an ANN may be trained by exposing the flame detector to a plurality of combinations of flame and false alarm sources. During training the output values are compared with the correct answer. At each iteration, the algorithm adjusts the weights of each connection Hᵢⱼ and Oⱼₖ in order to minimize the output error. After repeating this process for a sufficiently large number of training cycles, the network converges to a state where the error is small. Multi-layered ANNs and ANN training using the BP algorithm to set synaptic connection weights are described, e.g. in Rumelhart, D. E., Hinton, G. E. & Williams, R. J., Learning Representations by Back-Propagating Errors, (1986) Nature, 323, 533-536. It is shown that a multilayer network, containing one or two layers of hidden nodes, is required to handle non-linear decision boundaries.

In an exemplary embodiment, the ANN training involves a set of robust indoor and outdoor site tests. Data collected from these tests is used for ANN training performed on a personal or workstation computer equipped with MATLAB or a similar numerical computing program. The data can be collected using the hardware shown in FIG. 1, suitably mounted on a portable platform. U.S. Pat. No. 7,202,794 B2, the entire contents of which are incorporated herein by this reference, provides numerous examples of indoor and outdoor tests used for data collection and ANN training for a multi-spectral IR flame detector. The connection weights Hᵢⱼ and Oⱼₖ derived from such comprehensive ANN training can be loaded into the embedded software of prototype flame detectors for further validation through rigorous laboratory and field testing for consistent flame detection and rejection of false positives (via decision block 125, FIG. 3), as well as accurate radiant energy computation (via 123, FIG. 3). Subsequent to the successful validation, the connection weights Hᵢⱼ and Oⱼₖ may be programmed into manufactured units.

In an exemplary embodiment illustrated in FIG. 5, the ANN processing 122 outputs value 18′ that represent a percentage likelihood of a flame detected by the flame detection system. A threshold applied to the output sets the limit of the likelihood, above which a real flame condition is indicated. In an exemplary embodiment, neuron output 18′ value above 0.9 (on a scale of 0 to 1) indicates a strong likelihood of flame detection, whereas a smaller output indicates a strong likelihood of false alarm conditions. This analysis is conducted in ANN decision block 19.

Referring back to FIG. 3, post-processing 124 takes the output of the ANN 122 via the ANN decision block 19 (FIG. 5) and performs a final post-processing that may include other criteria such as factory or user defined criteria. Post-processing 124 may include post-processing such as counting the number of times the neuron output 18′ exceeds a threshold value as defined by the ANN decision block 19. For example, it may be desirable to have the neuron output 18′ exceed a threshold four times within a given time period, for example, one second, before the flame condition is output. This limits the likelihood of an isolated spurious input condition or transient to be interpreted as a flame condition thus causing a false alarm. In an exemplary embodiment, the threshold value may be set at 0.8 on a scale of 0 to 1.

Referring to FIG. 3, the output of the post-processing 124 is processed by decision block 125. In an exemplary embodiment, if decision block 125 determines that a flame has been detected, this decision is tied in with the output of threshold decision block 126 that compares the computed radiant energy versus a preset threshold. As described earlier, four output state combinations 127A, 1278, 127C, and 127D are possible for this exemplary embodiment. The outputs of these output states 127A, 1278, 127C, and 127D are continuously transmitted via output block 128 to the relays 23 and 24, display 25, analog output 26, and external communication interfaces such as Modbus 91 and HART 92. Output block 128 may be programmed by the user to define what is sent to the various user interfaces, e.g., the display may indicate the radiant energy regardless of whether it is caused by a flame or false alarm, or it may indicate the radiant energy only when it is determined to be caused by a flame. The user may also set an alarm radiant energy threshold via output block 128 to activate alarm relay 23 that is higher than the minimum radiant energy threshold set for decision block 126. The user may also program the output block 128 with a user settable time delay to ensure that an ANN determined flame event lasts for certain duration before taking corrective action via, for example, alarm relay 23.

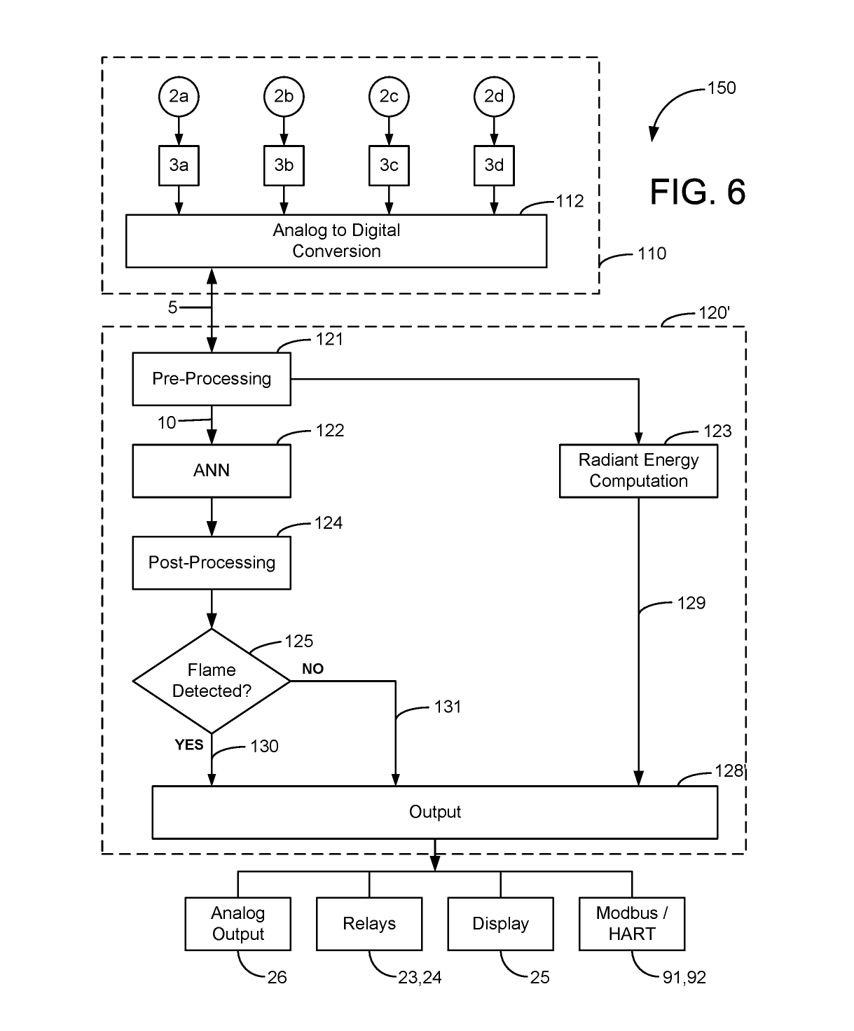

Referring now to FIG. 6, a functional block diagram 150 of another exemplary embodiment of a flame detector is depicted. This embodiment is similar to that described above regarding FIGS. 1-5. However, in this exemplary embodiment, the signal processor 6 is programmed to implement processing algorithms 120′, in which the computed radiant energy 123 is not compared against a preset threshold as shown in block 126 of FIG. 3. Rather, the computed radiant energy 129 is sent directly to the output block 128′. At the same time, the post processed ANN provides a determination via decision block 125 as to whether the optical signals are generated by a real flame indicated by output state 130 or by a false alarm as shown by output state 131, both in FIG. 6. The output block 128′ then informs the user of the presence (derived from or representing output state 130) and severity (derived from or representing signal 129) of a real flame via the output functions of the alarm relay 23, display 25, analog output 26, and external communication interfaces such as Modbus 91 and HART 92. If the computed radiant energy is shown to be created by a false alarm via output state 131 from decision block 125, the output block 128′ can similarly inform the user of the false alarm event and its severity via display 25, analog output 26, and external communication interfaces such as Modbus 91 and HART 92; in the case of a false alarm event indicated by output state 131 the alarm relay 23 would, however, not be activated.

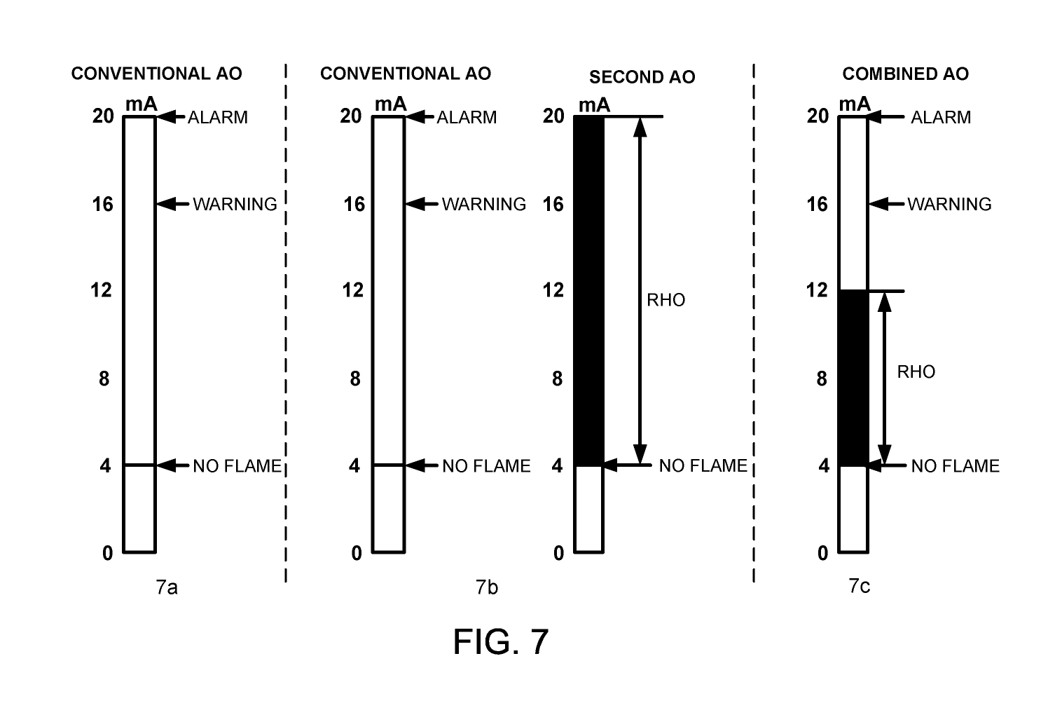

Referring now to FIG. 7, examples are shown as 7a, 7b, 7c as to how the radiant energy estimation could be outputted on the 0 to 20 mA analog output. 7a shows a conventional flame detector analog output with discrete outputs at 4 mA (no event) 16 mA (warning) and 20 mA (alarm). No radiant energy or heat estimation is provided. 7b shows a flame detector with two analog outputs, the first analog output is the conventional flame detector analog (of 7a) while the second analog output maps the radiant energy or heat (RHO) estimation continuously onto the 4 to 20 mA scale. Due to the substantial variation in received intensity, e.g., from a small fire at 210 feet distance to a much larger fire at closer distance, the mapping of radiometric energy to analog output would likely be logarithmic. 7c shows a combined or hybrid analog output scale that eliminates the second analog output of 7b by indicating the radiometric estimated value continuously between 4 and 12 mA. The 12 mA value typically represents the maximum unsaturated value of the sensor channel output signals. This third combined or hybrid scheme has the disadvantage that once a flame has been detected the analog output jumps to 16 and then 20 mA; the radiometric information is not available on the analog output once a flame event is recorded. This scheme may be called “trending” as it monitors the radiant heat prior to entering the alarm mode, but not once the flame detector is in the alarm mode.

In another embodiment, radiometric and flame detection status could be sent continuously to the user via serial communication such as Modbus 91 or HART 92 (FIG. 1). This allows the radiometric information to be transmitted continuously including during a flame event without the need for a second analog output.

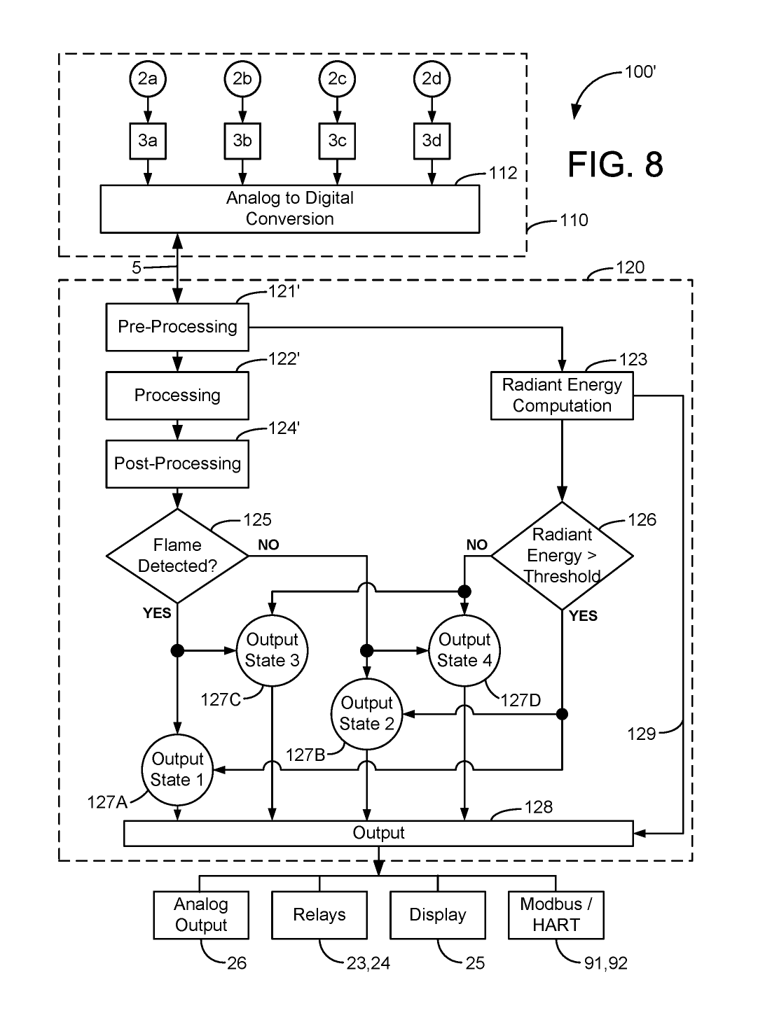

Referring now to FIG. 8, a functional block diagram 100′ of another exemplary embodiment of a flame detector is depicted. This embodiment is similar to that described above regarding FIGS. 1-3. However, processing block 122′ of FIG. 8 does not comprise an ANN as shown in 122 of FIG. 3. Rather expert based rules such as described in U.S. Pat. No. 6,150,659 may be used to decide on the presence or absence of a fire in decision block 125, following pre-processing block 121′, processing block 122′ and post-processing block 124′. U.S. Pat. No. 6,150,659, the entire contents of which are incorporated herein by this reference, utilizes two infrared detectors, one for detecting radiation emitted by hydrocarbon fires and the second for distinguishing infrared radiation from other sources such as modulated sunlight, artificial as well as natural hot objects, illuminating light sources and arc welders. The first infrared detector is followed by two electronic circuits such that a fire is sensed by either of the two circuits depending on its size, one circuit being optimized for flicker frequencies present in a large fire while the second circuit checks for optical signals at flicker frequencies dominant in a small fire. The two electronic outputs along with the output of the second infrared detector are digitally processed and analyzed for spectral and temporal characteristics to distinguish the presence of a real fire from that of various false alarm sources. FIG. 2 and FIG. 3 of U.S. Pat. No. 6,150,659 are detailed flow diagrams of the algorithms used and along with the text describing these algorithms details the rules followed in this expert rules based flame detection system. In this approach, a trained Artificial Neural Network is not used, instead the rules established by a human expert, i.e. predetermined rules, are followed to decide on the presence or absence of optical radiation emitted by flames.

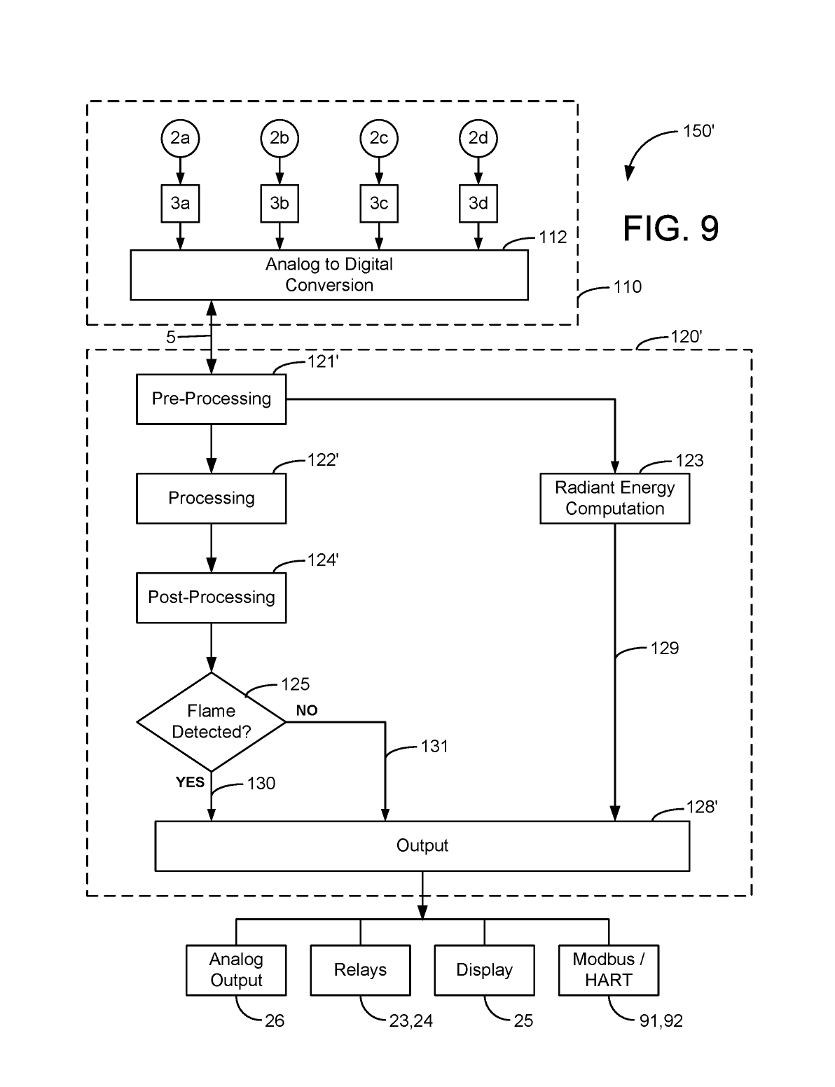

Referring now to FIG. 9, a functional block diagram 150′ of another exemplary embodiment of a flame detector is depicted. This embodiment is similar to that described above regarding FIG. 8. However, in this exemplary embodiment, the signal processor 6 is programmed to implement processing algorithms 120′, in which the computed radiant energy 123 is not compared against a preset threshold as shown in block 126 of FIG. 8. Rather, the computed radiant energy 129 is sent directly to the output block 128′. At the same time, the post processed signals 124′ provide a determination via decision block 125 as to whether the optical signals are generated by a real flame indicated by output state 130 or by a false alarm as shown by output state 131, both in FIG. 9. The output block 128′ then informs the user of the presence (from output state 130) and severity (from signal 129) of a real flame via the output functions of the alarm relay 23, display 25, analog output 26, and external communication interfaces such as Modbus 91 and HART 92. If the computed radiant energy is shown to be created by a false alarm via output state 131 from decision block 125, the output block 128′ can similarly inform the user of the false alarm event and its severity via display 25, analog output 26, and external communication interfaces such as Modbus 91 and HART 92; in the case of a false alarm event indicated by output state 131 the alarm relay 23 would, however, not be activated.

Although the foregoing has been a description and illustration of specific embodiments of the invention, various modifications and changes thereto can be made by persons skilled in the art without departing from the scope and spirit of the invention.

What is claimed is:

1. A method for radiant heat (IR) monitoring, flame detection and discrimination of real flame events from false alarms and quantification of radiant heat output from a surveilled scene, comprising the steps of:
deploying an optical sensor system to monitor the surveilled scene, the system having a plurality of infrared (IR) sensor channels, each channel including an IR sensor configured to receive optical energy from the surveilled scene within a field of view for monitoring the total radiation incident from all sources of radiation within a spectral bandwidth in which flames emit strong optical radiation;
producing sensor signals from each sensor channel to provide a quantitative indication of the total optical radiation received by the sensor channel within the spectral bandwidth within the field of view, said plurality of sensor channels each responsive to optical energy at different IR wavelengths from the other sensor channels;
digitally processing said signals to provide a flame present signal indicating detection of a real flame event, and to provide a quantitative indication signal of the radiant heat output (RHO) of the surveilled scene, said processing comprising:
processing signals derived from said sensor signals and applying Artificial Neural Network (ANN) coefficients configured to discriminate false alarm sources from real flames, and providing ANN outputs indicating a decision indicating whether a real flame has been detected, the ANN outputs including a first ANN output state indicating that a real flame has been detected, and a second ANN output state indicating that a real flame has not been detected;
processing signals derived from said sensor signals to calculate a quantitative indication of radiant energy output from the surveilled scene;
comparing the quantitative indication to a threshold and generating threshold comparator outputs indicating that the quantitative indication exceeds the threshold or does not exceed the threshold;
logically processing the ANN decision function signals and the threshold comparator outputs and generating output state signals, including an output state signal indicating that the ANN has detected a real flame event and that the quantitative indication exceeds the threshold; and
transmitting information including output state signals to a utilization device.

2. The method of claim 1, wherein the information transmitted to a utilization device includes said quantitative indication.

3. The method of claim 1, wherein logically processing step further includes:
generating a second output state signal indicative of a false alarm state corresponding to a condition that the ANN output does not indicate a fire event, and the quantitative indication exceeds the threshold;
generating a third output state signal indicative of a minor or small fire, corresponding to the condition that the ANN output indicates a real fire event and the quantitative indication does not exceed the threshold; and
generating a fourth output state signal indicative of a non fire event, corresponding to the condition that the ANN output indicates no fire event and the quantitative indication does not exceed the threshold.

4. A flame detector configured for radiant energy monitoring and quantification, comprising:
at least one optical sensor channel, each channel including an optical sensor configured to receive optical energy from a surveilled scene within a field of view at a hazardous location, each channel producing signals providing a quantitative indication of the optical radiation received by the optical sensor within a sensor spectral bandwidth, each channel configured for detecting optical radiation in a spectral region where flames emit strong optical radiation;
a processor responsive to the signals from the at least one optical sensor channel and configured to digitally process and analyze the signals to provide a flame present indication of detection of a real flame event, said processor comprising:
an Artificial Neural Network (ANN) responsive to signals derived from the at least one optical sensor channel for detecting a flame and providing a flame detected signal when the ANN detects a real flame;
a radiant energy calculator responsive to the at least one optical sensor channel signals to provide a quantitative indication of a radiant energy output of the surveilled scene; and
wherein the processor is configured to compare the quantitative indication against a threshold value, and to generate an output state signal indicative of a flame alarm only if the ANN provides said flame present indication of a real flame event and said quantitative indication of the radiant energy output exceeds said threshold.

5. The flame detector of claim 4, further comprising:
an outputting circuit for transmitting the flame alarm signal and the quantitative indication to a utilization device.

6. The flame detector of claim 4, wherein the optical sensor of the at least one optical sensor channel has a spectral bandwidth located in the infrared (IR) wavelength range.

7. The flame detector of claim 4, wherein the at least one optical sensor channel comprise an automatic gain circuit (AGC) with a corresponding plurality of variable attenuators to prevent or reduce saturation effects in the presence of high received optical energy, the AGC coupled to the respective IR sensors, and wherein the processor controls the AGC by providing AGC attenuation commands to the AGC variable attenuators, and said radiant energy calculator is responsive to values of said AGC commands to produce said quantitative indication signal.

8. The flame detector of claim 4, wherein said at least one optical sensor channel comprises a plurality of optical sensor channels each responsive to optical energy at different wavelengths from the other sensor channels.

9. The flame detector of claim 8, wherein the plurality of optical sensor channels each has a narrow operating bandwidth.

10. The flame detector of claim 9, wherein the plurality of optical sensor channels includes sensor channels for detecting IR energy at 4.3 micron and at 4.45 micron wavelengths, respectively.

11. The flame detector of claim 9, wherein the narrow bandwidth is on the order of 100 nanometers.

12. The flame detector of claim 4, wherein said output state signals further include:
a second output state signal indicative of a false alarm state corresponding to a condition that the ANN output does not indicate a fire event, and the quantitative indication exceeds the threshold;
a third output state signal indicative of a minor or small fire, corresponding to the condition that the ANN output indicates a real fire event and the quantitative indication does not exceed the threshold; and
a fourth output state signal indicative of a non fire event, corresponding to the condition that the ANN output indicates no fire event and the quantitative indication does not exceed the threshold.

13. The flame detector of claim 4, wherein the information transmitted to a utilization device includes said output state signal and said quantitative indication.

14. A flame detector configured for radiant heat (IR) monitoring, flame detection and discrimination of real flame events from false alarms and quantification of radiant heat output, comprising:
a plurality of infrared (IR) sensor channels, each channel including an IR sensor configured to receive optical energy from the surveilled scene within a field of view for monitoring the total radiation incident from all sources of radiation within a spectral bandwidth in which flames emit optical radiation, each channel producing sensor signals providing a quantitative indication of the total optical radiation received by the IR sensor within the spectral bandwidth within the field of view, said plurality of sensor channels each responsive to optical energy at different IR wavelengths from the other sensor channels;
a processor responsive to the signals from the optical sensor channels for digitally processing said signals to provide a flame present signal indicating detection of a real flame event, and to provide a quantitative indication signal of the radiant heat output (RHO) of the surveilled scene, the processor comprising:
an Artificial Neural Network (ANN) function for processing signals derived from said sensor signals and applying ANN coefficients configured to discriminate false alarm sources from real flames, and providing ANN outputs indicating a decision indicating whether a real flame has been detected, the ANN outputs including a first ANN output state indicating that a real flame has been detected, and a second ANN output state indicating that a real flame has not been detected;
a radiant energy computation function responsive to signals derived from said sensor signals to provide a quantitative indication of radiant energy output from the surveilled scene;
a threshold comparator to compare the quantitative indication to a threshold and generate threshold comparator outputs indicating that the quantitative indication exceeds the threshold or does not exceed the threshold;
combiner logic responsive to the ANN decision function signals and the threshold comparator outputs to generate output state signals, including an output state signal indicating that the ANN has detected a real flame event and that the quantitative indication exceeds the threshold; and
an outputting circuit responsive to the combiner logic for transmitting information to a utilization device.

15. The flame detector of claim 14, wherein the information transmitted to a utilization device includes said output state signals and said quantitative indication.

16. The system of claim 14, wherein the quantitative indication signal is configured to provide total or average radiometric energy of all said one or more IR sensor channels.

17. The system of claim 14, wherein the quantitative indication signal is configured to provide a weighted average of a radiometric value computed from the plurality of IR sensor channels.

18. The flame detector of claim 14, wherein the plurality of IR sensor channels comprise an automatic gain circuit (AGC) with a corresponding plurality of variable attenuators to prevent or reduce saturation effects in the presence of high received optical energy, the AGC coupled to the respective IR sensors, and wherein the processor controls the AGC by providing AGC attenuation commands to the AGC variable attenuators, and said radiant energy calculator is responsive to values of said AGC commands to produce said quantitative indication signal.

19. The flame detector of claim 14, wherein said output state signals further include:
a second output state signal indicative of a false alarm state corresponding to a condition that the ANN output does not indicate a fire event, and the quantitative indication exceeds the threshold;
a third output state signal indicative of a minor or small fire, corresponding to the condition that the ANN output indicates a real fire event and the quantitative indication does not exceed the threshold; and
a fourth output state signal indicative of a none fire event, corresponding to the condition that the ANN output indicates no fire event and the quantitative indication does not exceed the threshold.
